(19) United States
(12) Patent Application Publication
(10) Pub. No.: US 2008/0173834 A1
(43) Pub. Date: Jul. 24, 2008

(54) Malfunction Prevention Manual Valve

(75) Inventors: Tatsuhito Aoyama, Aichi (JP); Takashi Yajima, Iwate (JP); Masayoshi Morimoto, Aichi (JP)

Correspondence Address: OLIFF & BERRIDGE, PLC, P.O. BOX 320850, ALEXANDRIA, VA, 22320-4850, US

(73) Assignee: CKD CORPORATION, KOMAKI-SHI, AICHI (JP)

(21) Appl. No.: 11/885,737

(22) PCT Filed: Apr. 13, 2005
(86) PCT No.: PCT/JP05/07145

§ 371 Date: Sep. 6, 2007

(51) Int. Cl. F16K 35/00

(52) U.S. Cl. 251/89

(57) ABSTRACT

An object of the present invention is to provide a malfunction prevention manual valve capable of preventing a malfunction while ensuring operability in opening and closing the valve. To achieve the object, a malfunction prevention manual valve 1 of the present invention includes a lock mechanism including a parallel pin 75 held against rotation relative to a housing 71, and a sub-handle 73 provided in a handle 72 in such a manner as to be engageable with the parallel pin 75. The parallel pin 75 or the sub-handle 73 is urged by a lock spring 77, bringing the sub-handle in engagement with the parallel pin 75 to restrain rotation of the handle 72. A malfunction prevention manual valve 2 of another aspect includes a lock mechanism including a spring pin 175 held against rotation relative to a housing 171, a cam groove 172a formed in a handle 172 to receive a spring pin 175, and a sub-handle 173 provided integral with the handle 172 and urged by a spring 177.

### TECHNICAL FIELD

The present invention relates to a manual valve for fluid control and particularly to a malfunction prevention manual valve provided with a lock mechanism for preventing a valve from opening or closing unless an operator operates and arranged to ensure operability in opening and closing the valve.

### BACKGROUND ART

For instance, a semiconductor manufacturing system or the like includes an integrated valve for supplying a process gas to a chamber. Such an integrated valve is equipped with a manual valve for manually controlling opening and closing of the valve. FIGS. 22 and 23 are sectional views of one manual valve constituting the integrated valve, which is disclosed in JP9-264451 (1997)A. FIG. 22 shows a valve closed state and FIG. 23 shows a valve open state.

A manual valve 200 is placed in the valve closed state in which a valve element 201 is urged downward by a coil spring 202 to press a diaphragm 203 against a valve seat 211. Accordingly, a fluid having flowed in an inlet passage 252 through an inlet port 251 is blocked by the diaphragm 203. When an operator then rotates a handle 221, 90° counterclockwise, a cam 205 fixed to the handle 221 is caused to rotate 90° similarly.

FIG. 24 is a plan view of the cam 205. FIG. 25 is a sectional view of the cam 205 taken along a line A-A in FIG. 24. FIG. 26 is an exploded view of the cam 205. The cam 205 has a cylindrical shape centrally formed with a through hole 241 in which a center rod 204 is inserted. The cam 205 has an upper surface formed with a corrugated rolling surface on which a pair of radial bearings 231 and 231 are rotated. This corrugated rolling surface 235 is formed with upper recesses 233, 233 at a higher position and lower recesses 234, 234 at a lower position so that the pair of radial bearings 231, 231 are fitted therein and positioned in place.

Consequently, when the operator rotates the handle of the manual valve 200 in the valve closed state shown in FIG. 22, the cam 205 is rotated according to the handle 221, causing the radial bearings 231 to disengage from the lower recesses 234 and roll on the rolling surface 235. At this time, the radial bearings 231 roll as if ascending the slope of the rolling surface 235 and become fitted in the upper recesses 233. As a result, the center rod 204 is moved up by a height from the lower recess 234 to the upper recess 233 by way of a parallel pin 206. The center rod 204 is restrained from rotating by the parallel pin 207 and therefore will axially move but not rotate.

When the valve element 201 formed at the lower end of the center rod 204 is moved upward, the diaphragm 203 having been pressed till then by the valve element 201 is released to separate from the valve seat 211. This valve opening allows the fluid having flowed in the valve through the inlet port 251 to flow in a valve chamber 253 through a valve opening of the valve seat 211, and pass through an outlet passage 254 to flow out through an outlet port 255.

On the other hand, when the handle 221 of the manual valve 200 in the valve open state shown in FIG. 23 is rotated 90° reversely by the operator, the cam 205 is rotated, causing the radial bearings 231 to disengage from the upper recesses 233 and then engage with the lower recesses 234. The valve element 201 is thus moved down together with the center rod 204 by an urging force of the coil spring 202, thereby pressing the diaphragm 203 against the valve seat 211 to return to the valve closed state shown in FIG. 22.

| | |
|---|---|
| [Patent Document 1] | JP9-264451(1997)A (pages 4-5, FIGS. 1-5) |
| [Patent Document 2] | JP2000-97368A (pages 3-5, FIGS. 4, 5) |
| [Patent Document 3] | JP2002-323167A (pages 3-4, FIGS. 1, 2, 8) |

### DISCLOSURE OF THE INVENTION

### Problems to be Solved by the Invention

Meanwhile, in the case where the manual valve 200 of the patent document 1 mentioned as a prior art is mounted as a part of an integrated valve in which valves are spaced at small intervals, the operator often touches or hits the handle 221 with his/her hand while the operator is operating another valve to open or close. At those times, the handle 221 tends to turn on impact, causing the valve opening or closing. In the semiconductor manufacturing system using the integrated valve including the manual valve 200, accordingly, the manual valve caused to open by error may cause unnecessary process gas to be fed into the chamber, resulting in manufacturing failure. It is therefore necessary to avoid such a malfunction of the manual valve.

In this regard, there is a conventional manual valve provided with a lock mechanism. For example, JP2000-97368A discloses, as shown in FIG. 27, a configuration that a main body 303 internally formed with a valve seat is fixedly provided with an L-shaped lock member 301. The lock member 301 is formed with arms surrounding the periphery of a lower part of a handle 302 coupled to a valve element. By tightening a lock bolt 304, the handle 302 is held against movement relative to the main body 303. Further, the invention previously proposed by applicant of the present application and disclosed in JP2002-323167 is a manual valve arranged to restrain the valve from opening and closing with a padlock. Such the manual valve with the lock can prevent a malfunction reliably; however, it takes too long to detach the lock, resulting in a very troublesome work.

The present invention has been made to solve the above problems and has a purpose to provide a malfunction prevention manual valve capable of preventing a malfunction while ensuring operability in opening or closing the valve.

### Means for Solving the Problems

To achieve the above object, the invention according to claim 1 is characterized in a malfunction prevention manual valve including: a handle rotatable for operating opening and closing of the valve; a rod threaded in a housing in such a manner as to be movable in a vertical direction along a rotation axis of the handle; a power transmitting mechanism for transmitting rotation of the handle to the rod to cause the rod to move threadedly in the vertical direction; a valve section arranged to bring a valve element into and out of contact with a valve seat in association with vertical movement of the rod; and a lock mechanism for restraining the handle from rotating; wherein the lock mechanism includes a rotation stopper member held against rotation relative to the housing and an engagement member provided in the handle in such a manner as to be engageable with the rotation stopper member, and the lock mechanism is arranged to maintain a locked state in which the handle is restrained from rotating when one of the rotation stopper member and the engagement member is urged by an urging member and the engagement member engages with the rotation stopper member.

To achieve the above object, the invention according to claim 2 is characterized in that, in the malfunction prevention manual valve set forth in claim 1, the rotation stopper member is a parallel pin fixed diametrically extending across inside of the housing, and the engagement member is a sub-handle fixed to and under the handle in such a manner as to straddle the parallel pin, and the locked state in which the handle is restrained from rotating is maintained when the handle and the sub-handle are urged upward by the urging member and the parallel pin is engaged in a lock groove formed on an upper surface of the sub-handle.

To achieve the above object, the invention according to claim 3 is characterized in a malfunction prevention manual valve including: a handle rotatable for operating opening and closing of the valve; a rod threaded in a housing in such a manner as to be movable in a vertical direction along a rotation axis of the handle; a power transmitting mechanism for transmitting rotation of the handle to the rod to cause the rod to move threadedly in the vertical direction; a valve section arranged to bring a valve element into and out of contact with a valve seat in association with vertical movement of the rod; and a lock mechanism for restraining the handle from rotating; wherein the lock mechanism includes: a rotation stopper member held against rotation relative to the housing; a cam groove formed in the handle, in which the rotation stopper member is engaged; and the power transmitting mechanism arranged to be integral with the handle and be urged by an urging member.

To achieve the above object, the invention according to claim 4 is characterized in that, in the malfunction prevention manual valve set forth in claim 3, the rotation stopper member includes a pair of parallel pins fixed to the housing in diametrically opposite positions, the cam groove is formed in an almost inverted U-shape, and the power transmitting mechanism can be disengaged from the rod in the vertical direction.

To achieve the above object, the invention according to claim 5 is characterized in that, in the malfunction prevention manual valve set forth in claim 3, the rod includes a first rod and a second rod, and the first rod and the second rod can engage with and disengage from each other in an axial direction.

To achieve the above object, the invention according to claim 6 is characterized in a malfunction prevention manual valve including: a handle rotatable for operating opening and closing of the valve; a rod movable in a vertical direction along a rotation axis of the handle; a power transmitting mechanism for transmitting rotation of the handle to the rod by converting the rotation to vertical movement; a valve section arranged to bring a valve element into and out of contact with a valve seat in association with the vertical movement of the rod; and a lock mechanism for restraining the handle from rotating; wherein the lock mechanism includes a rotation stopper member held against rotation relative to the housing and an engagement member provided in the handle in such a manner as to be engageable with the rotation stopper member, and the lock mechanism is arranged to maintain a locked state in which the handle is restrained from rotating when one of the rotation stopper member and the engagement member is urged by an urging member and the engagement member engages with the rotation stopper member.

To achieve the above object, the invention according to claim 7 is characterized in that, in the malfunction prevention manual valve set forth in claim 6, the rotation stopper member is a lock plate to be restrained from rotation and made contact with a bottom surface of the handle by the urging member, the engagement member is a lock pin protruding from the bottom surface of the handle, and the locked state in which the handle is restrained from rotating is maintained when the lock pin is inserted in a lock hole formed in the lock plate.

To achieve the above object, the invention according to claim 8 is characterized in that, in the malfunction prevention manual valve set forth in claim 6, the rotation stopper member is a lock plate fixed to the housing and placed under the handle, the engagement member is a lock pin vertically extending through the handle and being urged downward by the urging member, and the locked state in which the handle is restrained from rotating is maintained when the urged lock pin is inserted in a lock hole formed in the lock plate.

To achieve the above object, the invention according to claim 9 is characterized in a malfunction prevention manual valve including: a handle rotatable for operating opening and closing of the valve; a rod movable in a vertical direction along a rotation axis of the handle; a power transmitting mechanism for transmitting rotation of the handle to the rod by converting the rotation to vertical movement; and a valve section arranged to bring a valve element into and out of contact with a valve seat in association with the vertical movement of the rod; wherein the handle is a plate shape pivoted on the rod protruding from an upper surface of the housing by a pin diametrically extending through the rod.

To achieve the above object, the invention according to claim 10 is characterized in that, in the malfunction prevention manual valve set forth in claim 9, the upper surface of the housing is formed with a protrusion for restraining rotation of the handle.

### EFFECTS OF THE INVENTION

The present invention is arranged as a malfunction prevention manual valve including: a handle rotatable for operating opening and closing of the valve; a rod threaded in a housing in such a manner as to be movable in a vertical direction along a rotation axis of the handle; a power transmitting mechanism for transmitting rotation of the handle to the rod to cause the rod to move threadedly in the vertical direction; a valve section arranged to bring a valve element into and out of contact with a valve seat in association with vertical movement of the rod; and a lock mechanism for restraining the handle from rotating. The lock mechanism includes a rotation stopper member held against rotation relative to the housing and an engagement member provided in the handle in such a manner as to be engageable with the rotation stopper member. The lock mechanism is arranged to maintain a locked state in which the handle is restrained from rotating when one of the rotation stopper member and the engagement member is urged by an urging member and the engagement member engages with the rotation stopper member. Accordingly, a malfunction in which the valve is opened or closed by error can be prevented. Further, the operability in opening and closing the valve can be ensured without lowering. Further, slow valve opening and closing operations can also be achieved.

The present invention is further arranged such that the rotation stopper member is a parallel pin fixed diametrically extending across inside of the housing, and the engagement member is a sub-handle fixed to and under the handle in such a manner as to straddle the parallel pin, and the locked state in which the handle is restrained from rotating is maintained when the handle and the sub-handle are urged upward by the urging member and the parallel pin is engaged in a lock groove formed on an upper surface of the sub-handle. Accordingly, a malfunction in which the valve is opened or closed by error can be prevented. Further, the operability in opening and closing the valve can be ensured without lowering. Further, slow valve opening and closing operations can also be achieved.

The present invention is further arranged as a malfunction prevention manual valve including: a handle rotatable for operating opening and closing of the valve; a rod threaded in a housing in such a manner as to be movable in a vertical direction along a rotation axis of the handle; a power transmitting mechanism for transmitting rotation of the handle to the rod to cause the rod to move threadedly in the vertical direction; a valve section arranged to bring a valve element into and out of contact with a valve seat in association with vertical movement of the rod; and a lock mechanism for restraining the handle from rotating. The lock mechanism includes: a rotation stopper member held against rotation relative to the housing; a cam groove formed in the handle, in which the rotation stopper member is engaged; and the power transmitting mechanism arranged to be integral with the handle and be urged by an urging member. Accordingly, a malfunction in which the valve is opened or closed by error can be prevented. Further, the operability in opening and closing the valve can be ensured without lowering and a valve open or closed state can be maintained reliably. Further, slow valve opening and closing operations can also be achieved.

The present invention is further arranged such that the rotation stopper member includes a pair of parallel pins fixed to the housing in diametrically opposite positions, the cam groove is formed in an almost inverted U-shape, and the power transmitting mechanism can be disengaged from the rod in the vertical direction. Accordingly, a malfunction in which the valve is opened or closed by error can be prevented. Further, the operability in opening and closing the valve can be ensured without lowering and a valve open or closed state can be held reliably. Further, slow valve opening and closing operations can also be achieved.

The present invention is further arranged such that the rod includes a first rod and a second rod, and the first rod and the second rod can engage with and disengage from each other in an axial direction. Accordingly, the valve seat receives only the urging force of the spring and therefore can be prevented from becoming broken down.

The present invention is further arranged as a malfunction prevention manual valve including: a handle rotatable for operating opening and closing of the valve; a rod movable in a vertical direction along a rotation axis of the handle; a power transmitting mechanism for transmitting rotation of the handle to the rod by converting the rotation to vertical movement; a valve section arranged to bring a valve element into and out of contact with a valve seat in association with the vertical movement of the rod; and a lock mechanism for restraining the handle from rotating. The lock mechanism includes a rotation stopper member held against rotation relative to the housing and an engagement member provided in the handle in such a manner as to be engageable with the rotation stopper member. The lock mechanism is arranged to maintain a locked state in which the handle is restrained from rotating when one of the rotation stopper member and the engagement member is urged by an urging member and the engagement member engages with the rotation stopper member. Accordingly, a malfunction in which the valve is opened or closed by error can be prevented. Further, the operability in opening and closing the valve can be ensured without lowering.

The present invention is further arranged such that the rotation stopper member is a lock plate to be restrained from rotation and made contact with a bottom surface of the handle by the urging member, the engagement member is a lock pin protruding from the bottom surface of the handle, and the locked state in which the handle is restrained from rotating is maintained when the lock pin is inserted in a lock hole formed in the lock plate. Accordingly, a malfunction in which the valve is opened or closed by error can be prevented. Further, the operability in opening and closing the valve can be ensured without lowering.

The present invention is further arranged such that the rotation stopper member is a lock plate fixed to the housing and placed under the handle, the engagement member is a lock pin vertically extending through the handle and being urged downward by the urging member, and the locked state in which the handle is restrained from rotating is maintained when the urged lock pin is inserted in a lock hole formed in the lock plate. Accordingly, a malfunction in which the valve is opened or closed by error can be prevented. Further, the operability in opening and closing the valve can be ensured without lowering.

The present invention is further arranged as a malfunction prevention manual valve including: a handle rotatable for operating opening and closing of the valve; a rod movable in a vertical direction along a rotation axis of the handle; a power transmitting mechanism for transmitting rotation of the handle to the rod by converting the rotation to vertical movement; and a valve section arranged to bring a valve element into and out of contact with a valve seat in association with the vertical movement of the rod. The handle is a plate shape pivoted on the rod protruding from an upper surface of the housing by a pin diametrically extending through the rod. Accordingly, a malfunction in which the valve is opened or closed by error can be prevented. Further, the operability in opening and closing the valve can be ensured without lowering.

The present invention is further arranged such that the upper surface of the housing is formed with a protrusion for restraining rotation of the handle. Accordingly, a malfunction in which the valve is opened or closed by error can be prevented. Further, the operability in opening and closing the valve can be ensured without lowering.

### BRIEF DESCRIPTION OF DRAWINGS

FIG. 1 is a sectional view of a malfunction prevention manual valve of a first embodiment;

FIG. 2 is a perspective view of a sub-handle constituting the malfunction prevention manual valve of the first embodiment;

FIG. 3 is a sectional view of a malfunction prevention manual valve of a second embodiment, particularly showing a locked state in a valve open state;

FIG. 4 is a sectional view of the malfunction prevention manual valve of the second embodiment, particularly showing an unlocked state in the valve open state;

FIG. 5 is a sectional view of the malfunction prevention manual valve of the second embodiment, particularly showing an unlocked state in a valve closed state;

FIG. 6 is a sectional view of the malfunction prevention manual valve of the second embodiment, particularly showing a locked state in the valve closed state;

FIG. 7 is a top view of the malfunction prevention manual valve of the second embodiment;

FIG. 8 is another top view of the malfunction prevention manual valve of the second embodiment;

FIG. 9 is a schematic diagram of a lock mechanism of the second embodiment;

FIG. 10 is a side view of a handle of the second embodiment;

FIG. 11 is a sectional view of a malfunction prevention manual handle of a third embodiment, particularly showing a locked state in a valve open state;

FIG. 12 is a sectional view of the malfunction prevention manual handle of the third embodiment, particularly showing an unlocked state in the valve open state;

FIG. 13 is a sectional view of the malfunction prevention manual handle of the third embodiment, particularly showing a locked state in a valve closed state;

FIG. 14 is a sectional view of the malfunction prevention manual handle of the third embodiment, particularly showing an unlocked state in the valve closed state;

FIG. 15 is a perspective view of a handle part of the malfunction prevention manual valve of the third embodiment;

FIG. 16 is another perspective view of a handle part of the malfunction prevention manual valve of the third embodiment;

FIG. 17 is a sectional view of a malfunction prevention manual valve of a fourth embodiment;

FIG. 18 is a sectional view of a malfunction prevention manual valve of a fifth embodiment;

FIG. 19 is an external view of the malfunction prevention manual valve of the fifth embodiment;

FIG. 20 is another external view of the malfunction prevention manual valve of the fifth embodiment;

FIG. 21 is another external view of the malfunction prevention manual valve of the fifth embodiment;

FIG. 22 is a sectional view of a conventional manual valve in a valve closed state, constituting an integrated valve;

FIG. 23 is a sectional view of the conventional manual valve in a valve open state, constituting an integrated valve;

FIG. 24 is a plan view of a cam for vertically moving a rod of the manual valve;

FIG. 25 is a sectional view of the cam for vertically moving the rod of the manual valve;

FIG. 26 is an exploded view of the cam for vertically moving the rod of the manual valve; and

FIG. 27 is a view showing a conventional manual valve with a lock mechanism.

### EXPLANATIONS OF REFERENCE NUMERALS

1 to 5 Malfunction prevention manual valve
50, 150 Valve body
51, 151 Inlet passage
52, 152 Outlet passage
53, 153 Diaphragm valve element
55, 155 Valve seat
61, 161 Stem
64, 164 Rod
71, 171 Housing
72, 172 Handle
73, 173 Sub-handle
66 Rotation transmitting pin
75 Parallel pin
158 Base
162 Rod guide
166 Handle rod
175 Spring pin

### BEST MODE FOR CARRYING OUT THE INVENTION

A detailed description of a preferred embodiment of a malfunction prevention manual valve embodying the present invention will now be given referring to the accompanying drawings.

It is to be noted that the term “upper” represents the side of a handle and the term “lower” represents the side of a valve body.

### FIRST EMBODIMENT

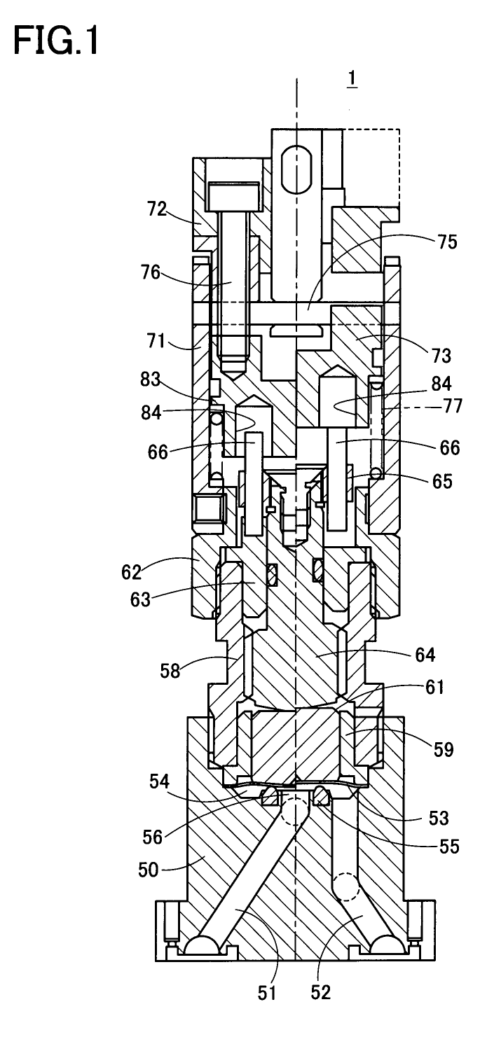

A malfunction prevention manual valve of a first embodiment according to the present invention will be explained below referring to the drawings. FIG. 1 is a sectional view showing a malfunction prevention manual valve 1 of the present embodiment, in which a right half shows in a locked state and a left half shows an unlocked state.

This malfunction prevention manual valve 1 is arranged such that a valve body 50 formed with an inlet passage 51 and an outlet passage 52 is mounted on a base block not shown or the like, and the valve is opened or closed by rotation of a handle 72 placed at an upper end.

The valve body 50 is a block component which can be mounted on the base block or the like and is formed with the inlet passage 51 and the outlet passage 52 each having a port opening in the bottom. The valve body 50 is formed with a recess opening upward in which a diaphragm 53 is placed on the bottom to define a valve chamber 54 communicating with the inlet passage 51 and the outlet passage 52. The inlet passage 51 is connected to a valve opening 56 formed inside a valve seat 55 centrally provided in the valve chamber 54. The outlet passage 52 is directly connected to the valve chamber 54 around the valve seat 15.

The valve body 50 is integrally coupled to an adaptor 58 threadedly inserted from above into the recess. In this state, the diaphragm 53 is held down by the adaptor 58 threadedly provided while the peripheral edge of the diaphragm 53 is sandwiched between the valve body 50 and a holder 59. Accordingly, this diaphragm 53 forms an airtight space serving as the valve chamber 54 which does not permit leakage of a fluid flowing from the inlet passage 51 to the outlet passage 52.

In the holder 59, a stem 61 is fitted to be slidable upward and downward. While the stem 61 is not held down, the diaphragm 53 is out of contact with the valve seat 55 by a spring force of the diaphragm 53, holding the stem 61 lifted.

A guide retainer 62 is threaded onto the periphery of the adaptor 58, thereby fixedly positioning a rod guide 63 in place. A rod 64 is inserted in the rod guide 63 in such a manner as to be slidable upward and downward. External threads of the rod 64 engage with internal threads of the adaptor 58. Specifically, this malfunction prevention manual valve 1 is configured such that the rod 64 with the external threads when given rotation moves threadedly along the internal threads, moving up or down in an axial direction, thereby releasing or holding down the stem 61 for closing or opening the valve.

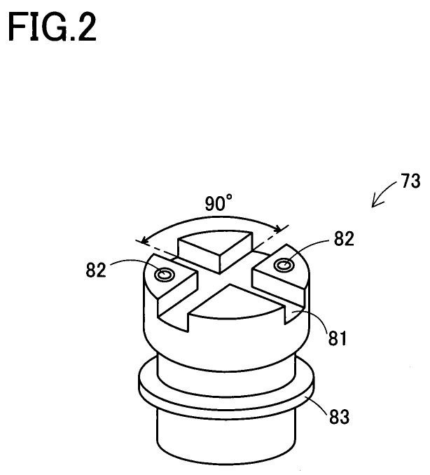

The guide retainer 62 is fixed to a housing 71 on which a handle 72 is located. Rotation of this handle 72 can be transmitted to the rod 64. In the housing 71, a parallel pin 75 is fixed intersecting a rotation axis. The handle 72 is coupled to a sub-handle 73 placed under the parallel pin 75 with a bolt 76. FIG. 2 is a perspective view of the sub-handle 73. The sub-handle 73 is formed, in its upper surface, with a cross-shaped lock groove 81 in which the parallel pin 75 can be fitted. A rotation range of the sub-handle 73 is an angle of 90°. Two bolts 76 are inserted in bolt holes 82, 82 shown in the figure to connect the handle 72 and the sub-handle 73 so that each bolt 72 does not interfere with the parallel pin 75 in the above range.

The sub-handle 73 is formed with a flange 38 through which the sub-handle 73 is urged upward by a lock spring 77 as shown in FIG. 1. Thus, the above malfunction prevention manual valve 1 is arranged such that the sub-handle 73 is normally urged upward by the lock spring 77, allowing the parallel pin 75 to be fitted in the lock groove 71, thereby maintaining a locked state.

Returning to FIG. 1, a fixed ring 65 is placed around an upper end of the rod 64. Two rotation transmitting pins 66, 66 are axially pressure-fitted in the ring 65. The sub-handle 73 is formed with rotation transmitting holes 84, 84 for receiving the rotation transmitting pins 66, 66. Accordingly, when the rotation transmitting pins 66, 66 can enter the rotation transmitting holes 84, 84, rotation of the handle 72 can be transmitted to the rod 64.

Operations of the malfunction prevention manual valve 1 of the present embodiment will be explained below. The malfunction prevention manual valve 1 is arranged, irrespective of either a valve open state or a valve closed state, such that the sub-handle 73 is pushed up by the lock spring 77 as shown in the right half in FIG. 1, bringing the lock groove 81 to engage with the parallel pin 75, thereby restraining the sub-handle 73 from rotating. This similarly disables rotation of the handle 72 coupled to the sub-handle 73 with the bolt 76. In this state, even when any force in the rotation direction is applied to the handle 72, the valve is not caused to open or close. In other words, the malfunction prevention manual valve 1 is normally in the open or closed state while being locked with the lock spring 77. This can avoid any problem caused by for example an operator who operates an adjacent manual valve and causes the handle 72 to rotate by error, switching the valve between the open state and the closed state.

On the other hand, to operate this malfunction prevention manual valve 1 to open or close, the operator presses down the handle 72 against the urging force of the lock spring 77 as shown in the left half in FIG. 1. Thus, the lock groove 81 of the sub-handle 73 is disengaged from the parallel pin 75, permitting rotation of the handle 72. Further, downward movement of the sub-handle 73 brings the rotation transmitting pins 66 to enter the rotation transmitting holes 84 respectively, and therefore the rotation of the handle 72 is ready to be transmitted. When the handle 72 pushed down is rotated 90°, the rotation thereof is transmitted to the sub-handle 73 through the bolt 76, and then to the rod 64 through the rotation transmitting pins 66 inserted in the rotation transmitting holes 84.

When given rotation, the rod 64 being threaded in the adaptor 58 is caused to axially move up or down through the respective threads. The rod 64 and the sub-handle 73 are coupled to each other by the rotation transmitting holes 84 and the rotation transmitting pins 66, so that the rod 64 can freely be moved up and down in the axial direction. When the rod 64 is moved down, the diaphragm 63 is pressed against the valve seat 55 through the stem 61 to open the valve. When the rod 64 is moved up, the stem 61 is released from the rod 64 and hence the diaphragm 53 separates from the valve seat 55 so as to lift the stem 61 by the elasticity of the diaphragm 53, thus closing the valve.

Consequently, the malfunction prevention manual valve 1 of the present embodiment includes the lock mechanism arranged to allow the parallel pin 75 to be fitted in the lock groove 81 of the sub-handle 73 urged by the lock spring 77. This makes it possible to prevent the valve from opening and closing by error unless an operator performs an unlocking operation. In the case where the malfunction prevention manual valve 1 is mounted as a part of an integrated valve, accordingly, this malfunction prevention manual valve 1 can be prevented from opening and closing by error when another valve is operated to open and close.

To unlock the malfunction prevention manual valve 1 of the present embodiment, the operator has only to push down the handle 72. At the opening or closing position, the operator has only to release the handle 72, so that a locked state is established by the lock spring 77. Accordingly, any special tool does not need to be used, and also very excellent operability allowing one-handed operation can be achieved.

Since the rod 64 threadedly engages with the adaptor 58, slow valve opening and closing operations can be carried out.

### SECOND EMBODIMENT

A second embodiment of the malfunction prevention manual valve according to the present invention will be explained below referring to drawings.

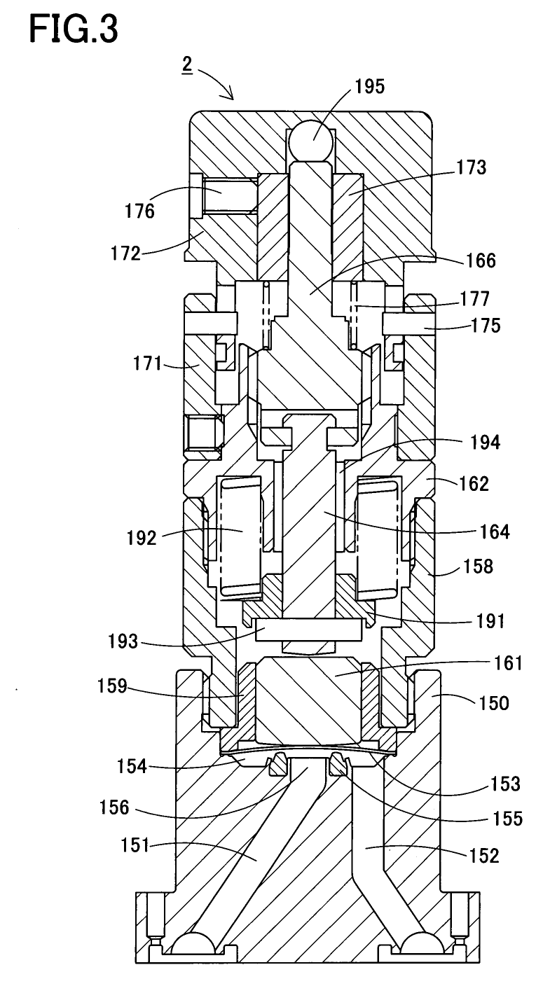

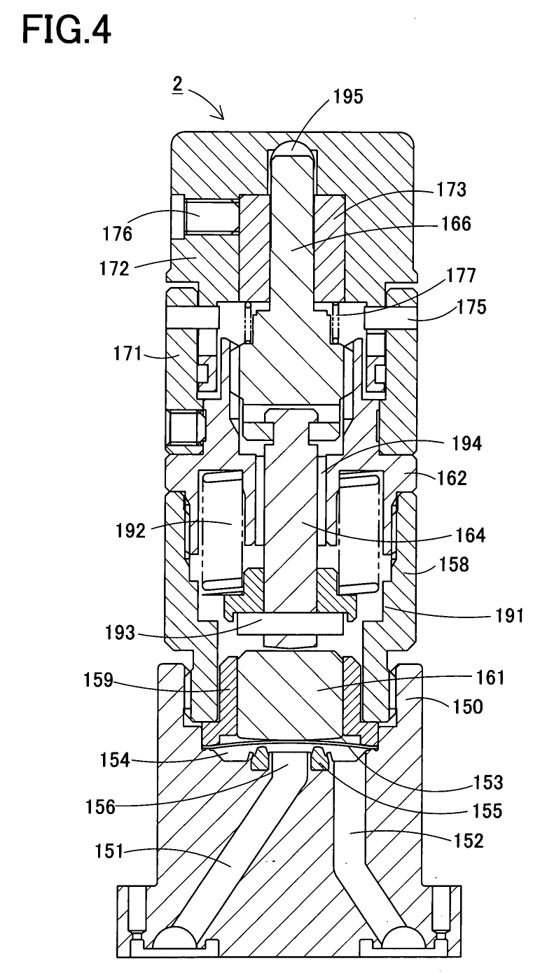

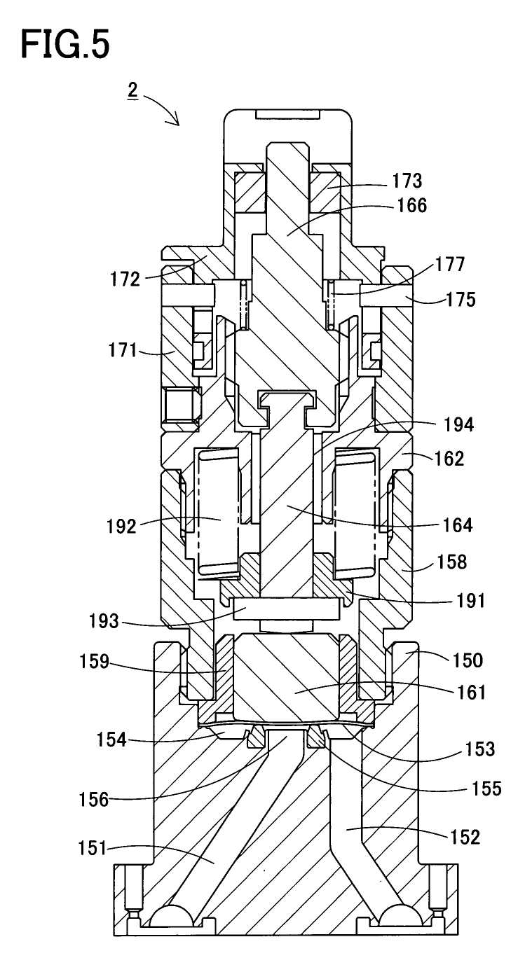

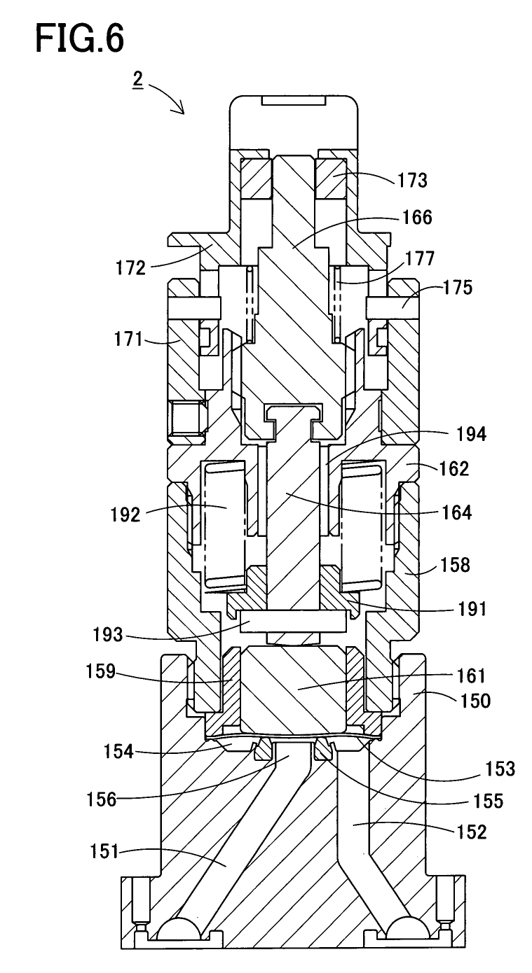

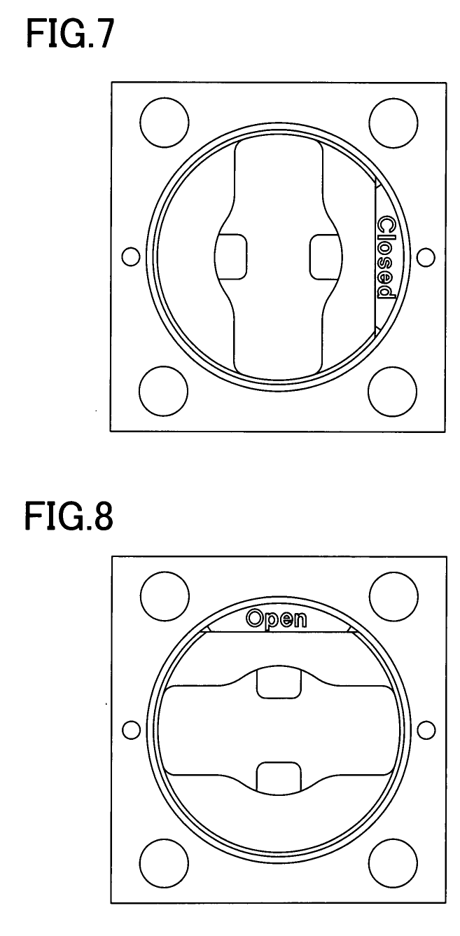

FIGS. 3 to 6 are sectional views of the malfunction prevention manual valve of the second embodiment. Of them, FIGS. 3 and 4 show a valve open state, and specifically FIG. 3 shows a locked state and FIG. 4 shows an unlocked state. FIGS. 5 and 6 show a valve closed state, and specifically FIG. 5 shows an unlocked state and FIG. 6 shows a locked state.

This malfunction prevention manual valve 2 is arranged such that a valve body 150 formed with an inlet passage 151 and an outlet passage 152 is mounted on a base block not shown or the like, and the valve is opened or closed by rotation of a handle 172 placed at an upper end.

The valve body 150 is a block component which can be mounted on the base block or the like is formed with the inlet passage 151 and the outlet passage 152 each having a port opening in the bottom. The valve body 150 is formed with a recess opening upward in which a diaphragm 153 is placed on the bottom to define a valve chamber 154 communicating with the inlet passage 151 and the outlet passage 152. The inlet passage 151 is connected to a valve opening 156 formed inside a valve seat 155 centrally provided in the valve chamber 154. The outlet passage 152 is directly connected to the valve chamber 154 around the valve seat 155.

The valve body 150 is integrally coupled to a base 158 threadedly inserted from above into the recess. In this state, the diaphragm 153 is held down by the base 158 threadedly provided while the peripheral edge of the diaphragm 153 is sandwiched between the valve body 150 and a holder 159. Accordingly, this diaphragm 153 forms an airtight space serving as the valve chamber 154 which does not permit leakage of a fluid flowing from the inlet passage 151 to the outlet passage 152.

In the holder 159, a stem 161 is fitted to be slidable upward and downward. While the stem 161 is not held down, the diaphragm 153 is out of contact with the valve seat 155 by a spring force of the diaphragm 153, holding the stem 161 lifted.

A rod guide 162 is threaded in the base 158 and hence fixed in place. A rod 164 is inserted in the rod guide 162 through a bush 194 in such a manner as to be slidable upward and downward.

Above the rod 164, a handle rod 166 is provided engaging with the rod 164. The rod 164 engages with the handle rod 166, but there is a clearance therebetween in an axial direction enough to allow the rod 164 to disengage from the handle rod 166 in the axial direction. External threads of the handle rod 166 engage with internal threads of the rod guide 162.

A spring support 191 is placed around a lower part of the rod 164. A spring 192 is disposed between the rod guide 162 and the spring support 191. The spring support 191 is supported against the urging force of the spring 192 by a parallel pin 193 inserted across the rod 164.

Specifically, this malfunction prevention manual valve 2 is configured such that, the handle rod 166 with the external threads when given rotation moves threadedly along the internal threads, the handle rod 166 and the rod 164 move up or down in the axial direction, thereby releasing or holding down the stem 161 for opening or closing the valve.

A handle 172 is provided above the rod guide 162. Spring pins 175 are radially fixed in a housing 171 and inserted in cam grooves 172a of the handle 172. The handle 172 is coupled to an internally provided sub-handle 173 with a bolt 176.

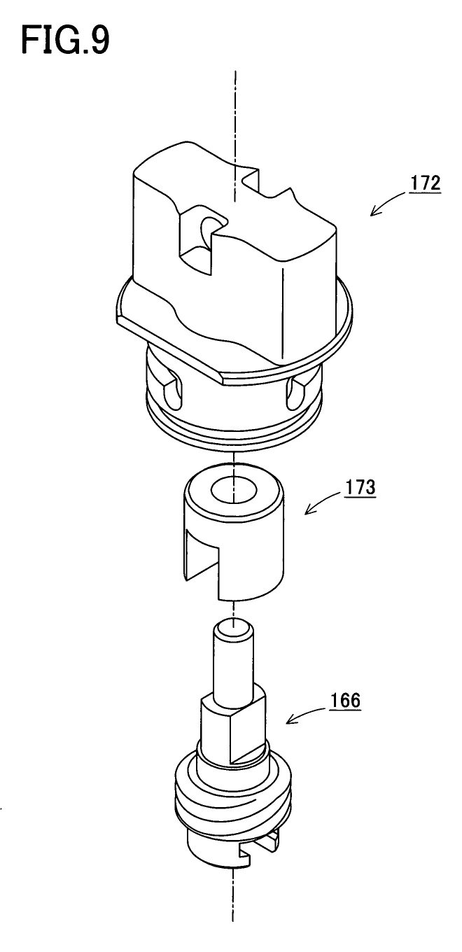

FIG. 9 shows a schematic diagram of a lock mechanism including the handle 172, the sub-handle 173, and the handle rod 166.

Operations of the malfunction prevention manual valve 2 of the present embodiment will be explained below. The malfunction prevention manual valve 2 is arranged, irrespective of either a valve open state or a valve closed state, such that the handle 172 is pushed up by the spring 177 via the sub-handle 173 as shown in FIG. 3 or 6, each spring pin 175 fixed in the housing 171 is positioned in a lock portion 172b of the cam groove 172a of the handle 172, thereby disabling rotation of the handle 173. In this state, even when any force in the rotation direction is applied to the handle 172, the valve is not caused to open or close. In other words, the malfunction prevention manual valve 2 in the normal state is normally in the open or closed state while being locked with the spring 177. This can avoid any problem caused by for example an operator who operates an adjacent manual valve and causes the handle 172 to rotate by error, switching the valve between the open state and the closed state.

On the other hand, to operate this malfunction prevention manual valve 2 to open or close, the operator presses down the handle 172 against the urging force of the spring 177 as shown in FIGS. 4 and 5. Thus, the position of the spring pin 175 fixed in the housing 171 is changed from the lock portion 172b of the cam groove 172a of the handle 172 to an unlock portion 172c to permit rotation of the handle 172.

Here, as shown in FIG. 9, the sub-handle 173 and the handle rod 166 are coupled to each other so that they move in the axial direction without interfering with each other but they are rotated at the same rotational phase in the circumferential direction.

Accordingly, when the handle 172 pushed down is rotated, the rotation thereof is transmitted to the handle rod 166 through the sub-handle 173.

When given rotation, the handle rod 164 being threaded in the rod guide 162 is caused to axially move up or down through the respective threads. Thus, the rod 164 engaging with the handle rod 166 is also caused to axially move up and down.

When the handle 172 is pushed down from the valve open state shown in FIG. 3 to the position shown in FIG. 4 and then rotated clockwise to move the handle rod 166 downward, the rod 164 having engaged with the handle rod 166 is disengaged from the handle rod 166. The rod 164 disengaged from the handle rod 166 is moved downward by the urging force of the spring 192 transmitted to the rod 164 through the spring support 191. Downward movement of the rod 164 presses the diaphragm valve element 153 against the valve seat 155 through the stem 161 as shown in FIG. 5, closing the valve. When the handle 172 in this state is released from hand, the handle 172 is moved upward by the urging force of the spring 177 through the sub-handle 173, coming into a position shown in FIG. 6.

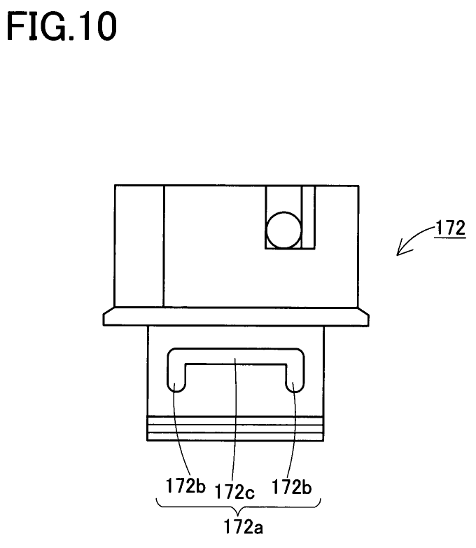

Here, the unlock portion 172c of the cam groove 172a of the handle 172 shown in FIG. 10 is formed to be longer than a length whereby the valve is actually opened or closed. Accordingly, when the handle 172 is fully rotated and then released from downward pressing, the spring pin 175 is positioned in the lock portion 172b. At this time, a valve section is surely placed in the valve open or closed state shown in FIG. 3 or 6.

On the other hand, when the handle 172 is pushed down from the valve closed state shown in FIG. 6 to a position shown in FIG. 5 and then rotated counterclockwise, moving the handle rod 166 upward, the rod 164 disengaged from the handle rod 166 is caused to engage with the handle rod 166. The rod 164 engaged with the handle rod 166 is moved upward against the urging force of the spring 192 transmitted through the spring support 191. Upward movement of the rod 164 releases the stem 161 from the rod 164 as shown in FIG. 4, so that the diaphragm valve element 153 separates from the valve seat 155 to push up the stem 161 by the elasticity, opening the valve. When the handle 172 is released from hand in this state, the handle 172 is moved upward by the urging force of the spring 177 through the sub-handle 173, coming to a position shown in FIG. 3.

The malfunction prevention manual valve 2 is further provided with a locking hole 195 in the handle 172. For example, a padlock can be attached to the locking hole 195. The padlock interferes with the handle rod 166 to disable the handle 172 from moving down. This makes it possible to reliably maintain the valve closed state or the valve open state of the valve section.

As above, the malfunction prevention manual valve 2 of the present embodiment includes: the handle 172 rotatable for controlling the opening and closing of the valve, the handle rod 166 threaded in the housing 171 in such a manner as to be movable up and down along the rotation axis of the handle 172, and the rod 164; the sub-handle 173 for transmitting rotation of the handle 172 to the rod 164 cause the handle rod 166 to threadedly move up and down; the valve section in which the diaphragm valve element 153 is brought into or out of contact with the valve seat 155 by downward and upward movement of the rod 164; and the lock mechanism for restraining the rotation of the handle 172. The lock mechanism includes the spring pin 175 held against rotation relative to the housing 171, the cam groove 172a formed in the handle 172 for receiving the spring pin 175, and the sub-handle 173 provided integral with the handle 172 and urged by the spring 177. Consequently, the valve can be prevented from opening and closing unless the operator releases the lock state. When the malfunction prevention manual valve 2 is mounted as a part of the integrated valve, accordingly, this malfunction prevention manual valve 2 will not be opened and closed by error when another valve is operated to open and close.

The malfunction prevention manual valve 2 of the present embodiment can be unlocked when the operator simply pushes down the handle 172. At the opening or closing position, when the operator releases the handle 172, the valve 2 is locked by the spring 177. Accordingly, any special tool does not need to be used, and also very excellent operability allowing one-handed operation can be achieved.

Further, the unlock portion 172c of the cam groove 172a of the handle 172 is formed with a length longer than a length whereby the valve is actually opened or closed. Accordingly, when the handle 172 is fully rotated and then released from downward pressing, the valve section can be opened or closed reliably. This valve open or closed state can be maintained surely by attachment of e.g. a padlock to the locking hole 195.

Since the handle rod 166 is threadedly moved, slow valve opening and closing operations can be carried out.

Further, according to the malfunction prevention manual valve 2 of the present embodiment, the spring pins 175 are a pair of parallel pins fixed to the housing 171 in diametrical opposed positions of the housing 171, the cam groove 172a is formed in an almost inverted U-shape, and the sub-handle 173 is disengageable from the handle rod 166 in a vertical direction. Accordingly, the valve 2 cannot be opened or closed unless an operator performs an unlocking operation. Thus, the malfunction prevention manual valve 2 is mounted as part of the integrated valve, this malfunction prevention manual valve 2 will not be opened and closed by error when another valve is operated to open and close.

The malfunction prevention manual valve 2 of the present embodiment can be unlocked when the operator simply pushes down the handle 172. At the opening or closing position, when the operator releases the handle 172, the valve 2 is locked by the spring 177. Accordingly, any special tool does not need to be used, and also very excellent operability allowing one-handed operation can be achieved.

Further, the unlock portion 172c of the cam groove 172a of the handle 172 is formed with a length longer than a length whereby the valve is actually opened or closed. Accordingly, when the handle 172 is fully rotated and then released from downward pressing, the valve section can be opened or closed reliably. This valve open or closed state can be maintained surely by attachment of e.g. a padlock to the locking hole 195.

Since the handle rod 166 is threadedly moved, slow valve opening and closing operations can be carried out.

In the malfunction prevention manual valve 2 of the present embodiment, furthermore, the handle rod 166 and the rod 164 are engageable with and disengageable from each other in the vertical direction. Accordingly, the valve seat 155 receives only the urging force of the spring 177 and therefore can be prevented from becoming broken.

### THIRD EMBODIMENT

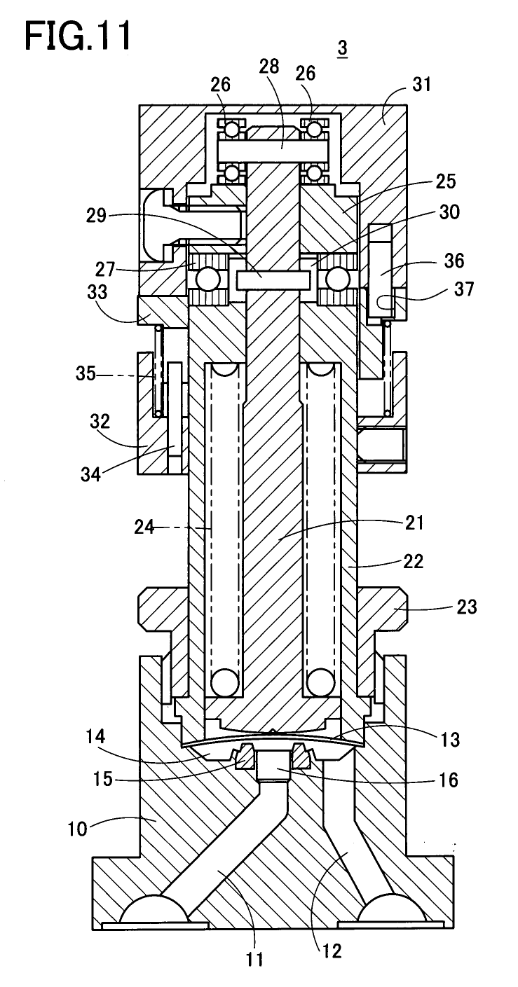

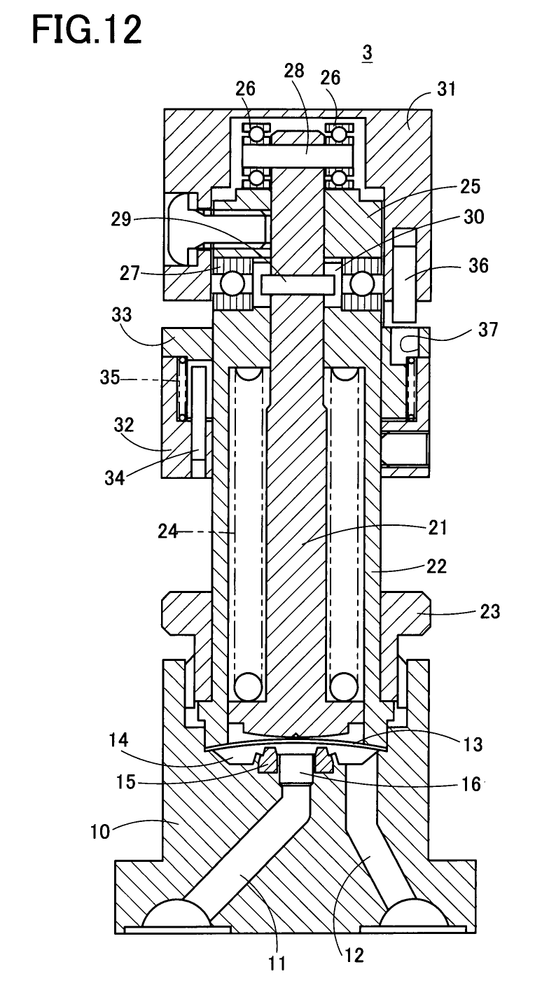

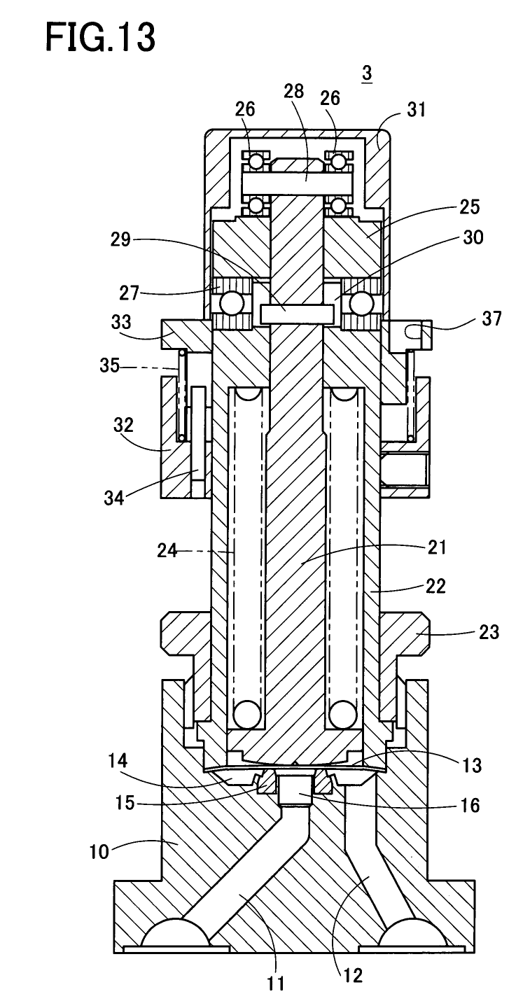

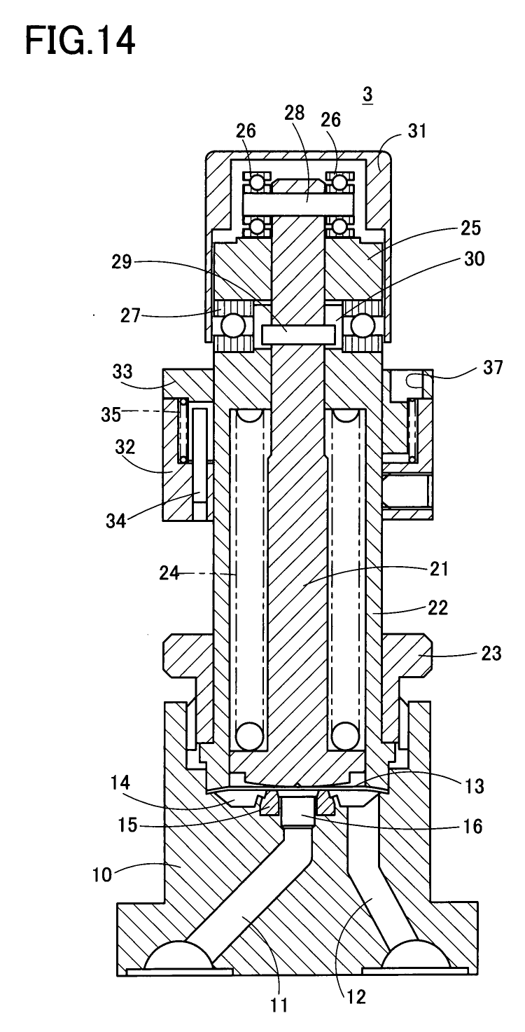

FIGS. 11 to 14 are sectional views of a malfunction prevention manual valve of a third embodiment. Of them, FIGS. 11 and 12 show a valve open state, and specifically FIG. 11 shows a locked state and FIG. 12 shows an unlocked state. FIGS. 13 and 14 show a valve closed state, and specifically FIG. 13 shows a locked state and FIG. 14 shows an unlocked state.

This malfunction prevention manual valve 3 is arranged such that a valve section is constituted of a valve body 10 formed with an inlet passage 11 and an outlet passage 12. By rotation of a handle 31, causing a center rod 21 to move up or down, the valve is opened or closed.

In the malfunction prevention manual valve 3 for constituting part of an integrated valve, the valve body 10 is a block component which can be mounted on a base block or the like not shown and is formed with the inlet passage 11 and outlet passage 12 each having a port opening in the bottom. The valve body 10 is formed with a recess opening upward in which a diaphragm 13 is placed on the bottom, and a space under the diaphragm 13 serves as a valve chamber 14 communicating with the inlet passage 11 and outlet passage 12. The inlet passage 11 is connected to a valve opening 16 formed inside a valve seat 15 centrally provided in the valve chamber 14. The outlet passage 12 is directly connected to the valve chamber 14 around the valve seat 15.

This valve body 10 is integrally coupled to a cylindrical housing 22 inserted therein from above and tightened with a holder nut 23. In this state, the peripheral edge of the diaphragm 13 is held down by the housing 22. The valve chamber 14 is airtight to prevent leakage of a fluid to the side of the center rod 21. The center rod 21 is placed in the housing 22 in such a manner as to protrude upward from the housing 22 in such a manner as to be vertically movable along the central axis. This center rod 21 is formed with a flange at a lower end. A spring 24 installed in the housing 22 bears on the flange. Accordingly, the center rod 21 is always urged downward by the spring 24, so that a round lower surface of the rod 21 presses the diaphragm 13 against the valve seat 15.

Next, a spring holder 32 is secured to the housing 22 with a screw. A protrusion of a lock plate 33 is inserted from above in a recess of the spring holder 32. The lock plate 33 is vertically slidable along the periphery of the housing 22. In particular, a stopper pin 34 fixed in a protruding condition to the spring holder 32 serves to restrict rotation of the lock plate 33 and guide vertical movement of the lock plate 33. A spring 35 is installed between the lock plate 33 and the spring holder 32 so that the lock plate 33 is always urged upward. Thus, the upper end of the lock plate 33 abuts on the bottom surface of the handle 31 located above the lock plate 33. The handle 31 is provided with a lock pin 36 protruding from the bottom surface and insertable in a lock hole 37 of the lock plate 33.

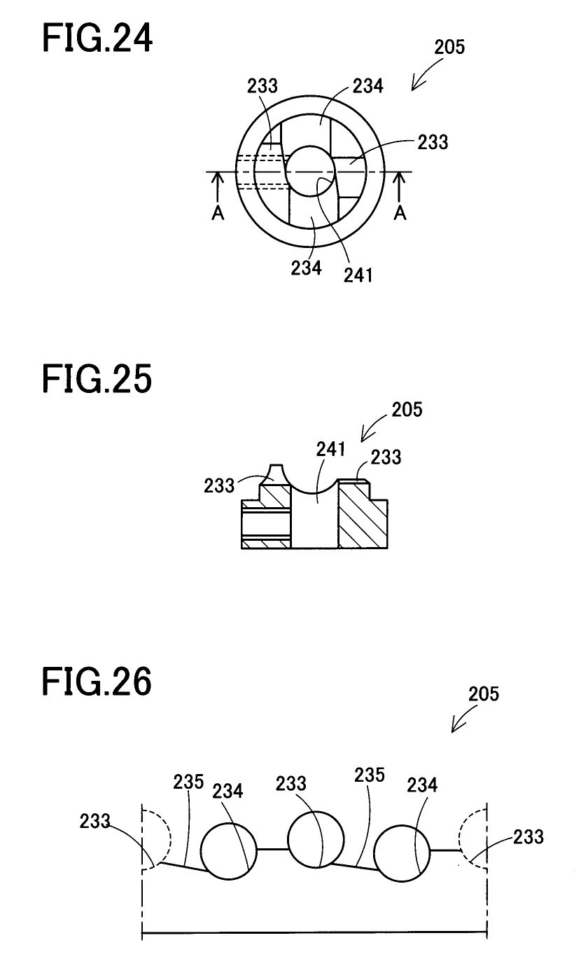

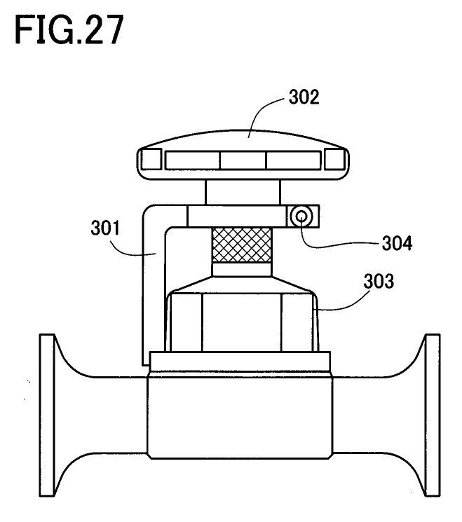

In the handle 31, a cam 25 is secured with a screw, a pair of radial bearings 26, 26 is placed above the cam 25, and a thrust bearing 27 is located under the cam 25. The cam 25 has the same configuration as the cam 205 shown in FIGS. 24 and 26, which is a cylindrical shape in which the center rod 21 is axially inserted, and an upper surface is formed as the corrugated rolling surface 235 on which the pair of radial bearings 26, 26 is rotated. The corrugated rolling surface 235 is formed with the upper recesses 233, 233 at a higher position and the lower recesses 234, 234 at a lower position so that each of the radial bearings 26, 26 is engageable therewith to be positioned in place.

The radial bearings 26, 26 are attached to both ends of a parallel pin 28 disposed through the center rod 21 so that the bearings 26, 26 are symmetrically disposed 180° away from each other about the central axis. While the cam 25 is rotated by operation of the handle 31, the radial bearings 26, 26 are rotated at fixed positions because of the center rod 21 that does not rotate. In other words, a parallel pin 29 is fixed to the center rod 21 at a portion corresponding to the thrust bearing 27 in such a manner as to be inserted in a groove 30 formed in a portion protruding from the housing 22. Thus, the rotation of the cam 25 is blocked by the parallel pin 29 and hence will not be transmitted to the center rod 21.

Operations of the malfunction prevention manual valve 3 of the present embodiment will be explained below. This malfunction prevention manual valve 3 is normally held in a locked state shown in FIGS. 11 and 13, irrespective of either a valve open state or a valve closed state. Specifically, the lock plate 33 urged by the lock spring 35 is held in contact with the handle 31, restraining rotation of the handle 31, establishing a malfunction prevention state. In other words, the immovable guide pin 34 is inserted in the lock plate 33, restraining rotation thereof. The lock pin 36 inserted in the lock hole 37 of the lock plate 33 restrained from rotating is fixed to the handle 31, so that the handle 31 is also restrained from rotating.

The above state is always maintained by the lock spring 35 unless an operator operates the malfunction prevention manual valve 3 to open or close. Thus, the handle 31 is not rotated erroneously when an adjacent manual valve is operated to open or close, and therefore the valve will not be switched between the open state and the closed state.

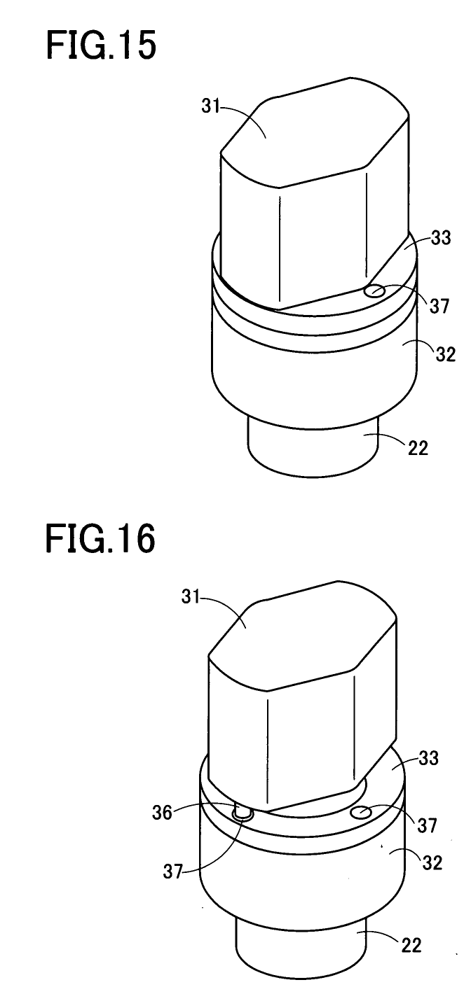

On the other hand, to operate this malfunction prevention manual valve 3 to open or close, the operator presses the lock plate 33 against the urging force of the lock spring 35 as shown in FIGS. 12 and 14. FIGS. 15 and 16 are perspective views of the malfunction prevention manual valve 3 seen from above. FIG. 15 shows a locked state and FIG. 16 shows an unlocked state.

For instance, the operator grasps the handle 31 in a state shown in FIG. 15 by covering it by hand and then pushes down the lock plate 33 by fingers. The lock plate 33 is thus moved down as shown in FIG. 16, allowing the lock pin 36 protruding downward from the handle 31 to disengage from the lock hole 37 of the lock plate 33, thus releasing the locked state. The operator then rotates the handle 31, 90° while holding down the lock plate 33.

The lock plate 33 is further formed with another lock hole 37 in a position to which the lock pin 36 is moved by 90°-rotation of the handle 31. Accordingly, when the lock plate 33 is released from holding-down, the lock plate 33 is pushed up by the lock spring 35, causing the lock pin 36 to engage with the lock hole 37, and comes to the locked state again. The malfunction prevention manual valve 3 of the present embodiment can be controlled to open or close by 90°-rotation of the handle 31. In both of the open and closed states, the locked state is established.

The malfunction prevention manual valve 3 is opened or closed by the following operations. In the malfunction prevention manual valve 3 in the state shown in FIGS. 11 and 12, the radial bearings 26, 26 are firstly fitted in the upper recesses 233, 233 of the cam 25 (see the cam 205 shown in FIGS. 24 to 26 having the same configuration as the cam 25, as needed). The center rod 21 remains lifted against the urging force of the spring 24. Accordingly, the diaphragm 13 is curved upward as in the figure to separate from the valve seat 15, placing the malfunction prevention manual valve 3 in the valve open state. Then, when the lock is released as mentioned above and the handle 31 is rotated, the cam 25 is simultaneously rotated, the radial bearings 26, 26 disengaged from the upper recesses 233, 233 are caused to rotate on the rolling surface 235.

The radial bearings 26, 26 then come to engagement with the lower recesses 234, 234 at the lower positions shown in FIGS. 13 and 14. In this state, the center rod 21 is urged downward by the spring 24, thereby pressing the diaphragm 13 against the valve seat 15. In this way, the valve opening 16 is closed by the diaphragm 13, placing the malfunction prevention manual valve 3 in the valve closed state. When the handle 31 is rotated reversely from the above position, the center rod 21 is moved up against the urging force of the spring 24. The diaphragm 13 is released and curved upward again as shown in FIGS. 11 and 12, placing the malfunction prevention manual valve 3 in the valve open state.

The malfunction prevention manual valve 3 of the present embodiment is arranged as mentioned above such that the valve is normally in the locked state by the lock pin 36 inserted in the lock plate 33 restrained from rotation by the urging force of the lock spring 35, so that the valve can be prevented from opening or closing due to an erroneous operation. Thus, the malfunction prevention manual valve 3 is mounted as part of the integrated valve, this malfunction prevention manual valve 3 cannot be opened or closed erroneously when another valve is operated to open or close.

Further, the malfunction prevention manual valve 3 of the present embodiment allows the operator to push down the lock plate 33 by his/her fingers while grasping the handle 31 to unlock. In the open or closed position, the lock plate 33 is pushed up the lock spring 35, thereby placing the valve 3 in the locked state. Thus, no special tool is needed and very excellent operability allowing one-handed operation can be achieved.

### FOURTH EMBODIMENT

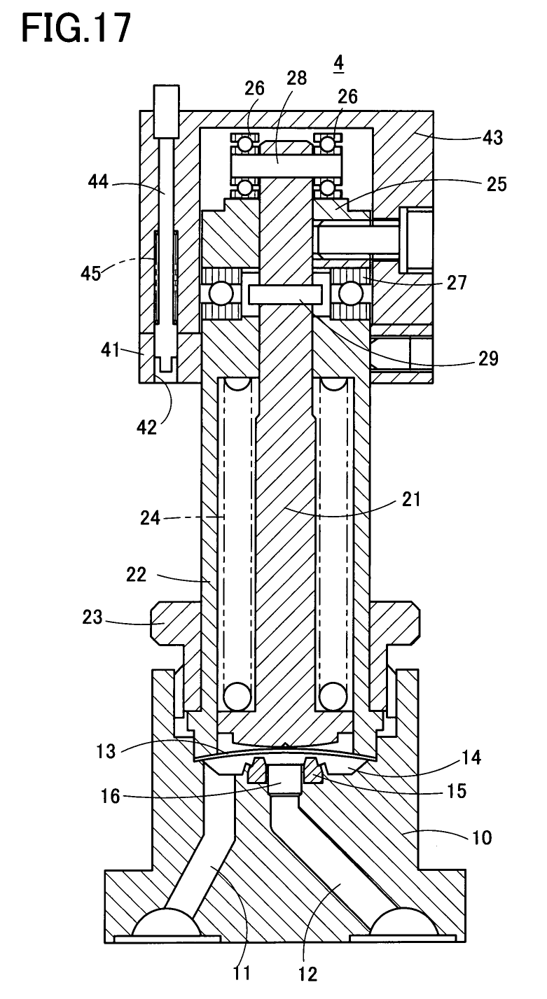

Successively, a fourth embodiment of the malfunction prevention manual valve according to the present invention will be described below referring to drawings. FIG. 17 is a sectional view of a malfunction prevention manual valve 4 of the present embodiment. The malfunction prevention manual valve 4 has the same configuration in the valve structure excepting a lock mechanism as in the third embodiment. Accordingly, the same parts or components are given the same reference numerals and their detailed explanations are not repeated.

As the lock mechanism of the malfunction prevention manual valve 4, a lock plate 41 is secured to the housing 22 with a screw. The lock plate 41 is formed with a lock hole 42 in which a lock pin 44 fitted in a handle 43 is inserted.

The lock pin 44 is inserted through the handle 43 and urged downward by a lock spring 45 installed in the handle 43. Accordingly, the lock pin 44 protrudes from the bottom surface of the handle 43 and is inserted in the lock hole 42 of the lock plate 41, so that the handle 43 is normally restrained from rotating.

When the malfunction prevention manual valve 4 of the present embodiment is to be opened or closed, the lock pin 44 is pulled up to be removed from the lock hole 42. Thus, the handle 43 is ready for rotation. When the handle 43 is rotated as above, the center rod 21 is moved up or down in association with upward or downward movement of the radial bearings 26, 26 caused by the cam 25. This makes the diaphragm 13 to come out of or into contact with the valve seat 15, thereby opening or closing the valve.

The malfunction prevention manual valve 4 of the present embodiment includes the lock mechanism arranged such that the lock pin 44 is inserted in the lock hole 42 of the lock plate 41. As in the third embodiment, the valve cannot be erroneously opened or closed unless an operator performs an unlocking operation. In the case where the malfunction prevention manual valve 4 is mounted as a part of an integrated valve, accordingly, this malfunction prevention manual valve 4 can be prevented from opening and closing by error.

The malfunction prevention manual valve 4 of the present embodiment can be unlocked in such a manner as that the operator pinches and pulls up the lock pin 44 by his/her fingers of the hand grasping the handle 43. At the open or closed position, the lock plate 33 is pushed up by the lock spring 45, establishing the locked state. Accordingly, any special tool does not need to be used, and also very excellent operability allowing one-handed operation can be achieved.

### FIFTH EMBODIMENT

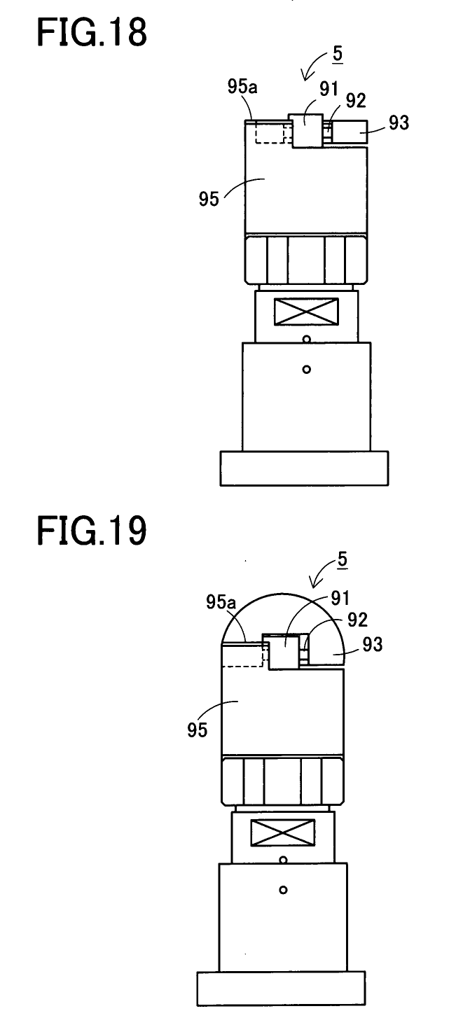

Successively, a fifth embodiment of the malfunction prevention manual valve according to the present invention will be described below referring to drawings. FIGS. 18 to 21 are external views of a malfunction prevention manual valve 5 of the present embodiment, showing opening and closing operations. The malfunction prevention manual valve 5 of the present embodiment is arranged for the purpose of preventing a malfunction as with the malfunction prevention manual valves of the first through fourth embodiments, but it includes no lock mechanism for restraining rotation.

This malfunction prevention manual valve 5 has the opening and closing mechanism configured as with that of the fifth embodiment. When a sub-rod 91 protruding upward is rotated, the rotation is transmitted to a rod threaded in the sub-rod 91. Upward and downward movements of the rod press or release a diaphragm through a stem to open and close the valve.

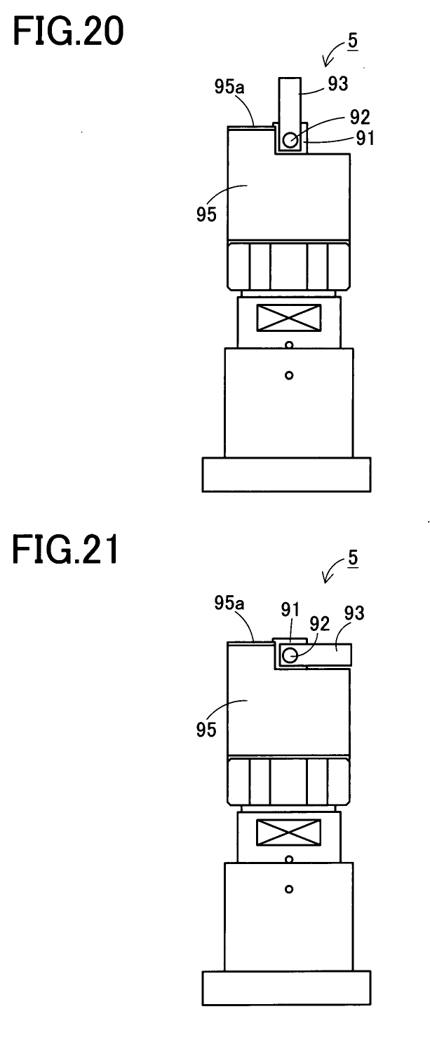

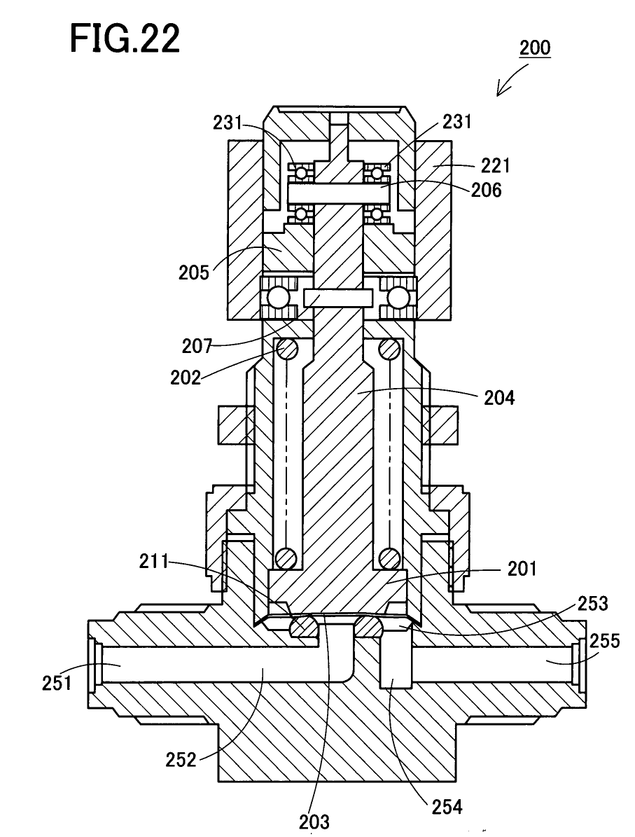

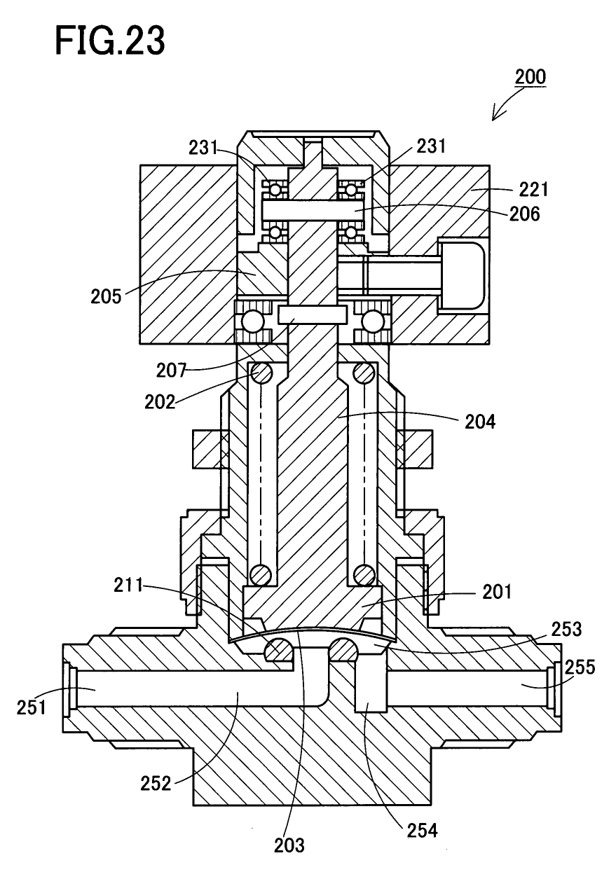

The sub-rod 91 is pin-connected to a semicircular handle 93 shown in FIG. 19 with a pin 92 diametrically extending through the sub-rod 91. The handle 93 can be switched between an upright position shown in FIGS. 19 and 20 and a sideways position shown in FIGS. 18 and 21. Particularly, the handle 93 receives an urging force of a spring not shown in a direction to turn sideways so that the handle 93 is in the sideways position except during the valve opening and closing operations.

On the other hand, the housing 95 is formed, on its upper surface, with a protrusion 95a for restraining the handle 93 from rotating. The protrusion 95a is provided in an angle range of 90° about the sub-rod 91. A rotatable range of the handle 93 on the upper surface of the housing 95 is set at 90°. Specifically, the malfunction prevention manual valve 4 can be opened or closed by rotating the handle 93, 90° about the sub-rod 91.

In the case where this malfunction prevention manual valve 5 is mounted as a part of an integrated valve, the handle 93 is normally in the sideways position shown in FIG. 18, so that the handle 93 is not rotated by error when another valve is operated to open or close. To switch the malfunction prevention manual valve 4 from the valve open state to the valve closed state, on the other hand, the handle 93 in the sideways position shown in FIG. 18 is raised up as shown in FIG. 19. Then, the handle 93 is pinched and rotated 90° as shown in FIG. 20. At this time, the protrusion 95a prevents the handle 93 from excessively rotating. Rotation of the sub-rod 91 is transmitted to the rod in the housing 95, thus closing the valve. When the operator releases his/her hand from the handle 93, the handle 93 automatically turns sideways as shown in FIG. 21. This makes it possible to rotate the handle 93 by error when another valve is operated to open or close.

According to the malfunction prevention manual valve 5 of the present embodiment, the sub-rod 91 is rotated by the handle 93 that can be turned sideways. In the case where the malfunction prevention manual valve 5 is mounted as a part of an integrated valve, accordingly, the malfunction prevention manual valve 2 can be prevented from opening and closing by error even when another valve is operated to open and close.

The malfunction prevention manual valve 5 of the present embodiment is controlled to open and close by the operator who raises and pinches the handle 93. Thus, no special tool is needed and very excellent operability allowing one-handed operation can be achieved.

Further, the handle 93, which can be turned sideways, is always held in the sideways position, so that the total height of the valve can be made lower and compact.

For the malfunction prevention manual valve of the present invention, the first to fifth embodiments have been explained referring to the drawings. The present invention may be embodied in other specific forms without departing from the essential characteristics thereof.

1. A malfunction prevention manual valve including:
a handle rotatable for operating opening and closing of the valve;
a rod threaded in a housing in such a manner as to be movable in a vertical direction along a rotation axis of the handle;
a power transmitting mechanism for transmitting rotation of the handle to the rod to cause the rod to move threadedly in the vertical direction;
a valve section arranged to bring a valve element into and out of contact with a valve seat in association with vertical movement of the rod; and
a lock mechanism for restraining the handle from rotating;
wherein the lock mechanism includes a rotation stopper member held against rotation relative to the housing and an engagement member provided in the handle in such a manner as to be engageable with the rotation stopper member, and the lock mechanism is arranged to maintain a locked state in which the handle is restrained from rotating when one of the rotation stopper member and the engagement member is urged by an urging member and the engagement member engages with the rotation stopper member.

2. The malfunction prevention manual valve according to claim 1, wherein the rotation stopper member is a parallel pin fixed diametrically extending across inside of the housing, and the engagement member is a sub-handle fixed to and under the handle in such a manner as to straddle the parallel pin, and
the locked state in which the handle is restrained from rotating is maintained when the handle and the sub-handle are urged upward by the urging member and the parallel pin is engaged in a lock groove formed on an upper surface of the sub-handle.

3. A malfunction prevention manual valve including:
a handle rotatable for operating opening and closing of the valve;
a rod threaded in a housing in such a manner as to be movable in a vertical direction along a rotation axis of the handle;
a power transmitting mechanism for transmitting rotation of the handle to the rod to cause the rod to move threadedly in the vertical direction;
a valve section arranged to bring a valve element into and out of contact with a valve seat in association with vertical movement of the rod; and
a lock mechanism for restraining the handle from rotating;
wherein the lock mechanism includes:
a rotation stopper member held against rotation relative to the housing;
a cam groove formed in the handle, in which the rotation stopper member is engaged; and
the power transmitting mechanism arranged to be integral with the handle and be urged by an urging member.

4. The malfunction prevention manual valve according to claim 3, wherein the rotation stopper member includes a pair of parallel pins fixed to the housing in diametrically opposite positions,
the cam groove is formed in an almost inverted U-shape, and
the power transmitting mechanism can be disengaged from the rod in the vertical direction.

5. The malfunction prevention manual valve according to claim 3, wherein the rod includes a first rod and a second rod, and
the first rod and the second rod can engage with and disengage from each other in an axial direction.

6. A malfunction prevention manual valve including:
a handle rotatable for operating opening and closing of the valve;
a rod movable in a vertical direction along a rotation axis of the handle;
a power transmitting mechanism for transmitting rotation of the handle to the rod by converting the rotation to vertical movement;
a valve section arranged to bring a valve element into and out of contact with a valve seat in association with the vertical movement of the rod; and
a lock mechanism for restraining the handle from rotating;
wherein the lock mechanism includes a rotation stopper member held against rotation relative to the housing and an engagement member provided in the handle in such a manner as to be engageable with the rotation stopper member, and
the lock mechanism is arranged to maintain a locked state in which the handle is restrained from rotating when one of the rotation stopper member and the engagement member is urged by an urging member and the engagement member engages with the rotation stopper member.

7. The malfunction prevention manual valve according to claim 6, wherein the rotation stopper member is a lock plate to be restrained from rotation and made contact with a bottom surface of the handle by the urging member, the engagement member is a lock pin protruding from the bottom surface of the handle, and
the locked state in which the handle is restrained from rotating is maintained when the lock pin is inserted in a lock hole formed in the lock plate.

8. The malfunction prevention manual valve according to claim 6, wherein the rotation stopper member is a lock plate fixed to the housing and placed under the handle,
the engagement member is a lock pin vertically extending through the handle and being urged downward by the urging member, and
the locked state in which the handle is restrained from rotating is maintained when the urged lock pin is inserted in a lock hole formed in the lock plate.

9. A malfunction prevention manual valve including:
a handle rotatable for operating opening and closing of the valve;
a rod movable in a vertical direction along a rotation axis of the handle;
a power transmitting mechanism for transmitting rotation of the handle to the rod by converting the rotation to vertical movement; and
a valve section arranged to bring a valve element into and out of contact with a valve seat in association with the vertical movement of the rod;
wherein the handle is a plate shape pivoted on the rod protruding from an upper surface of the housing by a pin diametrically extending through the rod.

10. The malfunction prevention manual valve according to claim 9, wherein the upper surface of the housing is formed with a protrusion for restraining rotation of the handle.
